(19) United States
(12) Patent Application Publication
(10) Pub. No.: US 2007/0234262 A1
(43) Pub. Date: Oct. 4, 2007

(54) Method and apparatus for inspecting element layout in semiconductor device

(75) Inventors: Masato Uedi, Kasugai (JP); Mamoru Sobue, Kasugai (JP); Kouhei Nagaya, Kasugai (JP); Takeshi Inoue, Kasugai (JP); Yoshinori Gotou, Kasugai (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/523,040

(22) Filed: Sep. 19, 2006

(30) Foreign Application Priority Data
Mar. 29, 2006 (JP) 2006-091275

(51) Int. Cl. G06F 17/50

(52) U.S. Cl. 716/11

(57) ABSTRACT

A method for inspecting the layout of elements included in a semiconductor device. The method includes setting paired layout inspection requirements including at least an element interval at which a paired layout is enabled, inspecting whether or not the elements that are to be inspected for paired layout satisfy the paired layout inspection requirements, setting a search area for each of the elements that are to be inspected for paired layout, and extracting figures included in the search areas of the elements that are to be inspected for paired layout and inspecting whether or not the extracted figures of the elements that are to be inspected for paired layout are congruent to each other.

### CROSS-REFERENCE TO RELATED APPLICATIONS

This application is based upon and claims the benefit of priority from prior Japanese Patent Application No. 2006-091275, filed on Mar. 29, 2006, the entire contents of which are incorporated herein by reference.

### BACKGROUND OF THE INVENTION

The present invention relates to an apparatus and a method for inspecting whether or not the layout of elements in a semiconductor device satisfies layout requirements.

With the increase in size and integration level of semiconductor devices (LSIs), the quantity of data used for designing semiconductor devices has also increased. The design of a semiconductor device includes the task of inspecting whether or not the layout of elements satisfies various layout requirements. This layout inspection requires a long period of time. There is a demand for shortening the inspection time.

One type of layout designing for semiconductor devices arranges a plurality of elements (two elements, for example) in pairs. The paired layout is a technique for arranging elements having the same shapes and dimensions in proximity to each other to equalize the influence from peripheral elements and peripheral patterns. The paired layout allows the elements to have substantially identical characteristics. For example, a differential circuit or a current mirror circuit is required to have a plurality of transistors having the same characteristics. In such a circuit, the paired layout of transistors reduces or minimizes the difference in characteristics between the transistors.

Japanese Laid-Open Patent Publication Nos. 2001-229215 and 2001-175700 propose an inspection apparatus for inspecting whether or not the paired layout is correct. Such conventional inspection apparatus inspects whether or not the paired layout of elements is appropriate based on the type of the elements, distance between the elements, and orientation of the elements. The paired layout inspection conducted by an inspection apparatus of the prior art will be described below with reference to FIGS. 21A to 21G. Elements C1 and C2 are subjected to inspection.

In the example shown in FIG. 21A, the elements C1 and C2 are of the same type and in the same orientation (in terms of rotation and inversion). In this case, the prior art inspection apparatus determines that the elements C1 and C2 are paired in the layout.

In the example shown in FIG. 21B, the elements C1 and C2 are arranged under different layout conditions. In this case, the prior art inspection apparatus determines that the elements C1 and C2 are not paired in the layout.

The triangles shown in FIGS. 21A and 21B indicate reference points of the elements C1 and C2. It can be seen by comparing the reference points that the element C2 in FIG. 21B is obtained by rotating the element C2 in FIG. 21A counterclockwise by 90 degrees.

### SUMMARY OF THE INVENTION

The prior art inspection apparatus sometimes fails to correctly inspect paired layouts.

In a case where layout data having no hierarchy (or classified) structure, such as in the layout shown in FIG. 21C, data representing transistor gates G1 and G2 and diffusion layers D1 to D4 do not have any information indicating relationships therebetween, the prior art inspection apparatus cannot extract element shapes and layout positions. Thus, it cannot be determined whether the transistor gates G1 and G2 are laid out as a pair.

The prior art inspection apparatus cannot correctly inspect a paired layout when the layout includes components that have not been defined (see FIGS. 21D, 21E, 21F, and 21G).

For example, when the layout includes a wiring P1 (FIG. 21D) for adding a contact during designing or a wiring P2 (FIG. 21E) extending over the element C2, such elements, or wirings P1 and P2, are not comparison subjects. Therefore, the prior art inspection apparatus will erroneously determine that the elements C1 and C2 are laid out as a pair.

In the example shown in FIG. 21F, a dummy cell C3 is arranged adjacent to the element C2. The dummy cell C3 is not a comparison subject. Therefore, the prior art inspection apparatus will erroneously determine that the elements C1 and C2 are laid out as a pair.

In the example shown in FIG. 21G, wirings P3 and P4 respectively connected to the elements C1 and C2 extend in different directions. The wirings P3 and P4 are not comparison subjects. Therefore, the prior art inspection apparatus will erroneously determine that the elements C1 and C2 are laid out as a pair.

In this manner, inspection with the prior art inspection apparatus requires an inspector to take the time and trouble to visually check the paired layout inspection results. When the inspector overlooks an error during the visual checking, this may lead to the production of a defective semiconductor device that functions differently during actual use from the simulated operation. Such visual checking, which requires much time and trouble, delays the designing.

One aspect of the present invention is a layout inspection method for inspecting the layout of a plurality of elements included in a semiconductor device. The method includes setting paired layout inspection requirements including at least an element interval at which a paired layout is enabled, inspecting whether or not the elements that are to be inspected for paired layout satisfy the paired layout inspection requirements, setting a search area for each of the elements that are to be inspected for paired layout, and extracting figures included in the search areas of the elements that are to be inspected for paired layout and inspecting whether or not the extracted figures of the elements that are to be inspected for paired layout are congruent to each other.

A further aspect of the present invention is a layout inspection apparatus for inspecting the layout of a plurality of elements included in a semiconductor device. The apparatus includes a processing circuit programmed to set paired layout inspection requirements including at least an element interval at which a paired layout is enabled, inspect whether or not the elements that are to be inspected for paired layout satisfy the paired layout inspection requirements, set a search area for each of the elements that are to be inspected for paired layout, extracting figures included in the search areas of the elements that are to be inspected for paired layout, and inspect whether or not the extracted figures of the elements that are to be inspected for paired layout are congruent to each other. A memory device, connected to the processing circuit, holds the paired layout inspection requirements.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram showing a layout inspection apparatus according to a preferred embodiment of the present invention;

FIG. 2 is a flowchart illustrating a layout inspection method according to a preferred embodiment of the present invention;

FIGS. 3 and 4 are detailed flowcharts illustrating the layout inspection method;

FIG. 5 is a diagram showing an example of an element layout;

FIG. 6 is a diagram showing an example of a control card;

FIG. 7 is a circuit diagram of an extracted element;

FIG. 8 is a schematic view showing the shapes of the element shown in FIG. 7;

FIGS. 9A to 9C are explanatory diagrams illustrating the inspection method;

FIGS. 10A to 10D are explanatory diagrams illustrating the inspection method;

FIG. 11A is a circuit diagram showing elements that are to be inspected, FIG. 11B is a diagram showing the layout of the elements shown in FIG. 11A, and FIG. 11C is a table of the inspection results;

FIG. 12A is a circuit diagram of elements that are to be inspected, FIG. 12B is a diagram showing the layout of the elements shown in FIG. 12A, and FIG. 12C is a table of inspection results;

FIG. 13A is a diagram showing the layout of elements that are to be inspected, and FIG. 13B is a table of the inspection results;

FIG. 14A is a diagram showing the layout of elements that are to be inspected, and FIG. 14B is a table of inspection results;

FIG. 15A is a diagram showing the layout of elements that are to be inspected, and FIG. 15B is a table of inspection results;

FIG. 16 is a table of inspection results;

FIG. 17A is a diagram showing the layout of elements that are to be inspected, and FIG. 17B is a table of the inspection results;

FIG. 18A is a table showing the layout of elements that are to be inspected, and FIG. 18B is a table of the inspection results;

FIG. 19A is a diagram showing the layout of elements that are to be inspected, and FIG. 19B is a table showing the inspection results;

FIG. 20 is a table showing the inspection results; and

FIGS. 21A to 21G are diagrams showing inspection examples of elements laid out in pairs.

### DESCRIPTION OF THE PREFERRED EMBODIMENTS

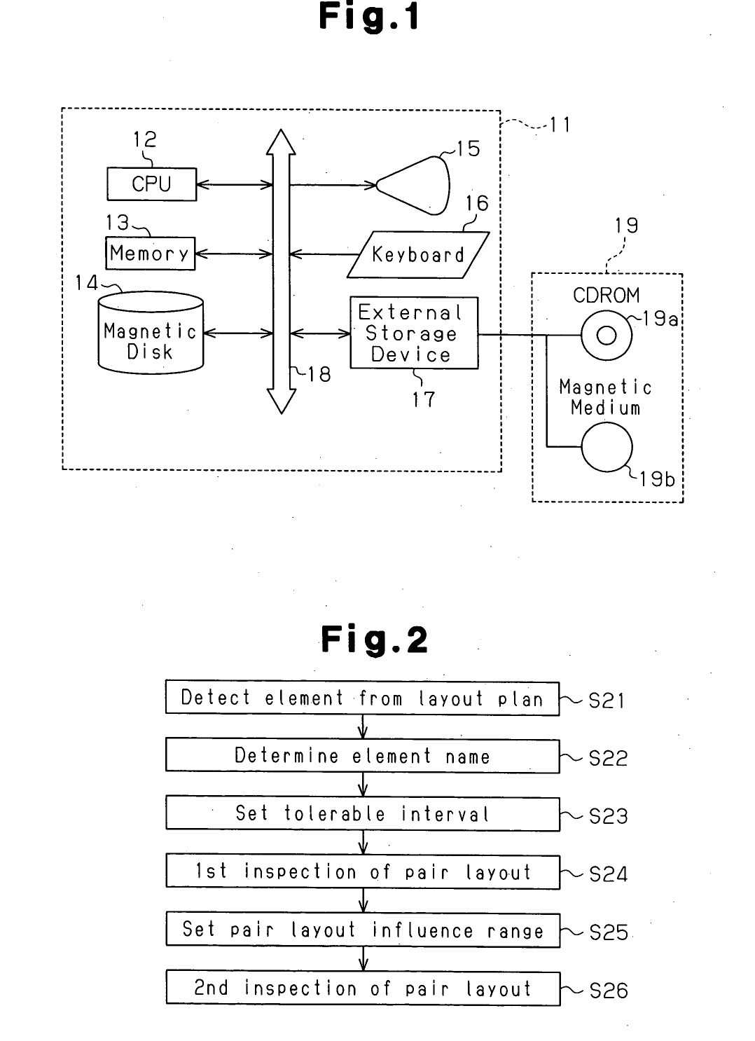

A computer apparatus 11 performing a layout inspection process according to a preferred embodiment of the present invention will now be discussed with reference to FIG. 1.

The computer apparatus 11 is a typical CAD system and includes a central processing unit (CPU) 12, a memory 13, a magnetic disk 14, a display device 15, an input device 16, an external storage device 17, and a bus 18.

Using the memory 13, the CPU 12 executes a program to perform layout inspection processing on a semiconductor device. The memory 13 stores programs and data required for performing various processing. The memory 13 may be a cache memory, a system memory, or a display memory (not shown).

The display device 15 is used to display layouts and a parameter entry screen. The display device 15 is for example a CRT, an LCD, or a PDP (not shown). The input device 16 is used by a user to enter requests, instructions, and parameters. The input device 16 is, for example, a keyboard and a mouse device (not shown).

The magnetic disk 14 may be a magnetic disk device, an optical disk device, or a magneto-optical disc device (not shown). The magnetic disk 14 stores various electronic files such as program codes, netlists and layouts used for semiconductor device layout inspection processing. In response to a signal from the input device 16, the CPU 12 transfers the program codes to the memory 13 and sequentially executes the program codes.

The external storage device 17 drives and accesses a recording medium 19, which provides the computer apparatus 11 with program codes executed by the CPU 12. The CPU 12 installs the program codes read from the recording medium 19 into a magnetic disk 14.

The recording medium 19 is a computer-readable recording medium including, for example, an optical disk 19a, such as a CD-ROM or a DVD, and/or a magnetic medium 19b, such as a magnetic tape (MT), flexible disk, or a magneto-optical disk (MO, MD, or the like). The recording medium 19 may be replaced by a semiconductor memory or a hard disk device externally connected to the computer. The program codes stored in the recording medium 19 may be loaded in the memory 13 whenever necessary.

The recording medium 19 is, for example, a medium on which recording program codes are uploaded or downloaded via a communication medium, a disk device, or a storage device of a server connected to the computer apparatus 11 via a communication medium. The recording medium 19 may be a recording medium on which programs directly executed by the computer are recorded, a recording medium on which program codes are executed after being installed in another recording medium (e.g., a hard disk), or a recording medium on which encrypted or compressed program codes are recorded.

A process for inspecting paired layouts in a semiconductor device layout data (layout plan) will now be described.

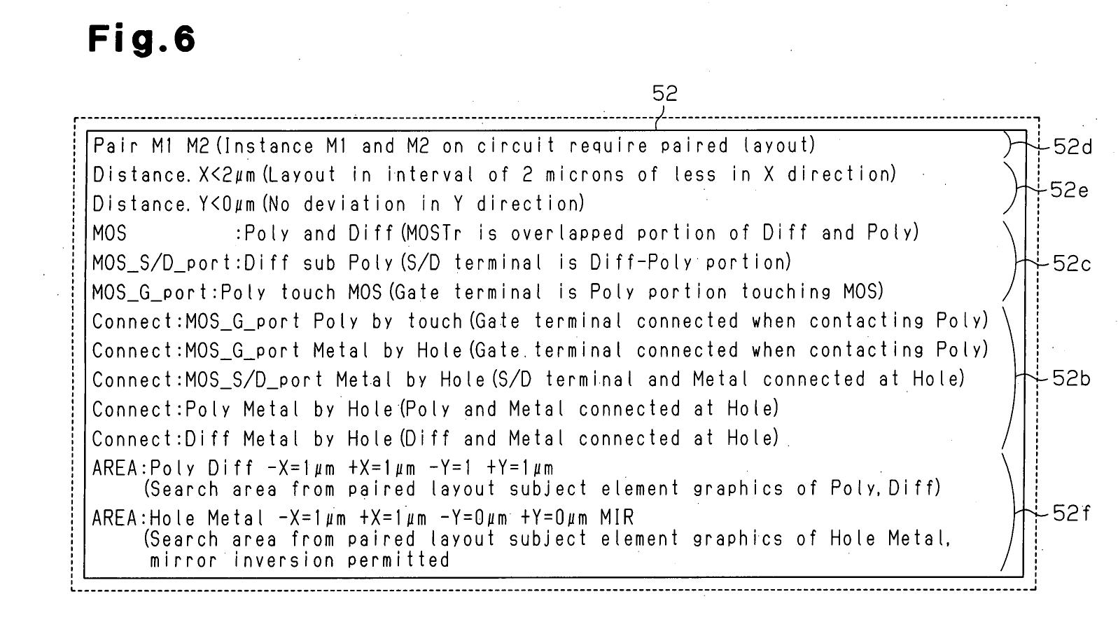

Referring to FIG. 2, in step 21, the CPU 12 detects elements included in a semiconductor device based on a layout plan and a control card of the semiconductor device (see FIG. 6). The control card can be a data file containing definitions of elements that are to be paired in the layout. The control card contains definition information such as element names and layout restrictions, graphic information and connection information of element components such as wirings, and search area information. The CPU 12 detects the shapes and layout positions of the elements from the layout plan based on the information in the control card.

The graphic information corresponds to the database information defining the elements, and the layout plan is generated based on a netlist and the definition information in the database. Therefore, even if the layout plan includes graphic information that is not hierarchized or classified, an element formed from a plurality of figures (for example, MOS transistor) may be detected by comparing the shapes of the figures contained in the layout plan with the graphic information contained in the control card.

In step 22, the CPU 12 checks the connection state of the elements detected in step 21 and determines the element name from the netlist. In step 23, the CPU 12 sets the names of the elements that must to be paired in the layout and a tolerable interval value for the paired layout based on the control card.

In step 24 (first inspection step), the CPU inspects the paired layout based on the determined element name, the figure shapes, the layout positions, and the tolerable interval. The inspection is performed by comparing the element shapes and inspecting the interval between the elements. More specifically, the CPU 12 compares the shapes of elements arranged adjacent to each other to determine whether or not the shapes of the elements are congruent to each other. The CPU 12 calculates the interval between elements from the layout positions and determines whether or not the interval is within the tolerable interval value.

In step 25 (second inspection step), based on the control card, the CPU 12 sets a range including figures that affect the elements to be inspected for paired layout as a search area. In step 26, the CPU 12 extracts the figures in the search area from the layout plan and inspects whether or not the shapes, dimensions and arrangements of the figures are the same for the elements that are to be inspected for paired layout. If at least one of the shapes, dimensions and arrangements is not the same, the CPU 12 reverses or rotates the figures of the elements. After this alteration, the CPU 12 determines whether or not the shapes and dimensions of the figures match between the elements that are to be inspected for paired layout and whether or not the relative positions of the figures are the same.

As described above, the CPU 12 extracts elements from the layout plan and inspects whether the elements are paired in the layout by using the figures of the extracted elements. Therefore, the paired layout inspection can be performed even if the layout plan has no hierarchy structure. This reduces the trouble and time required for visual inspection.

Further, a search area is set for each of the elements that are to be paired in the layout and wirings included in the search area are extracted to inspect the shapes and the layout positions of the elements including the extracted figures. This reduces determination errors.

The paired layout inspection process will now be discussed in detail.

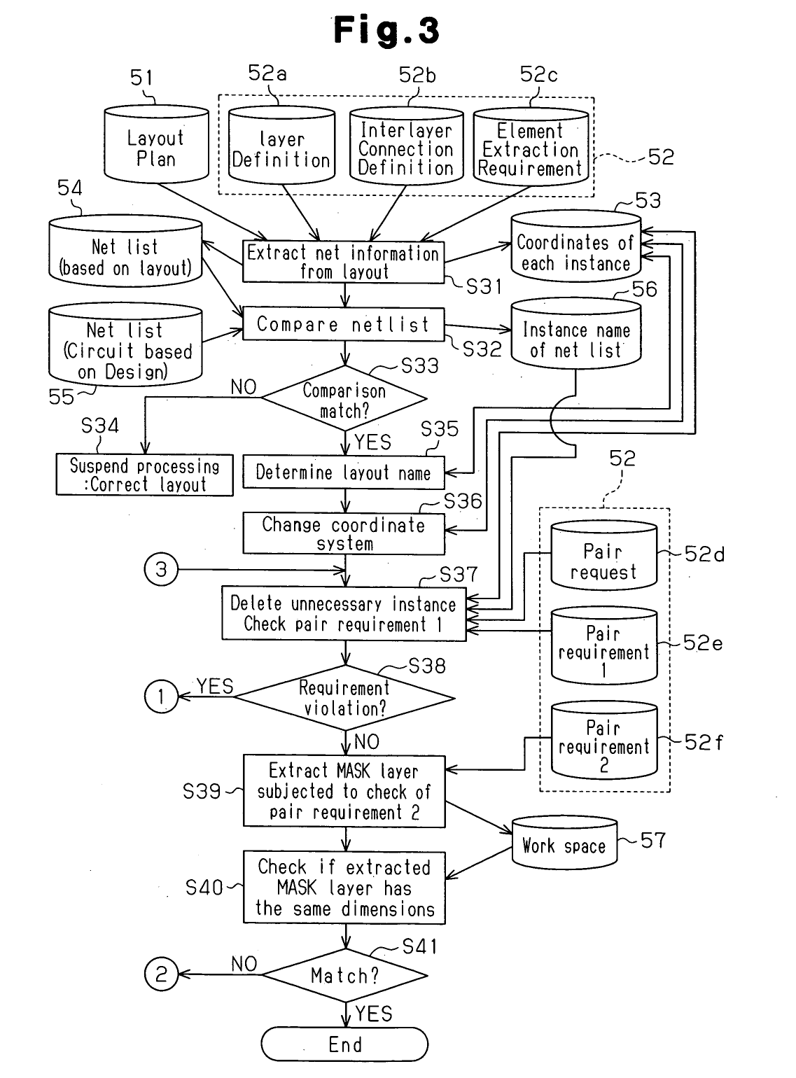

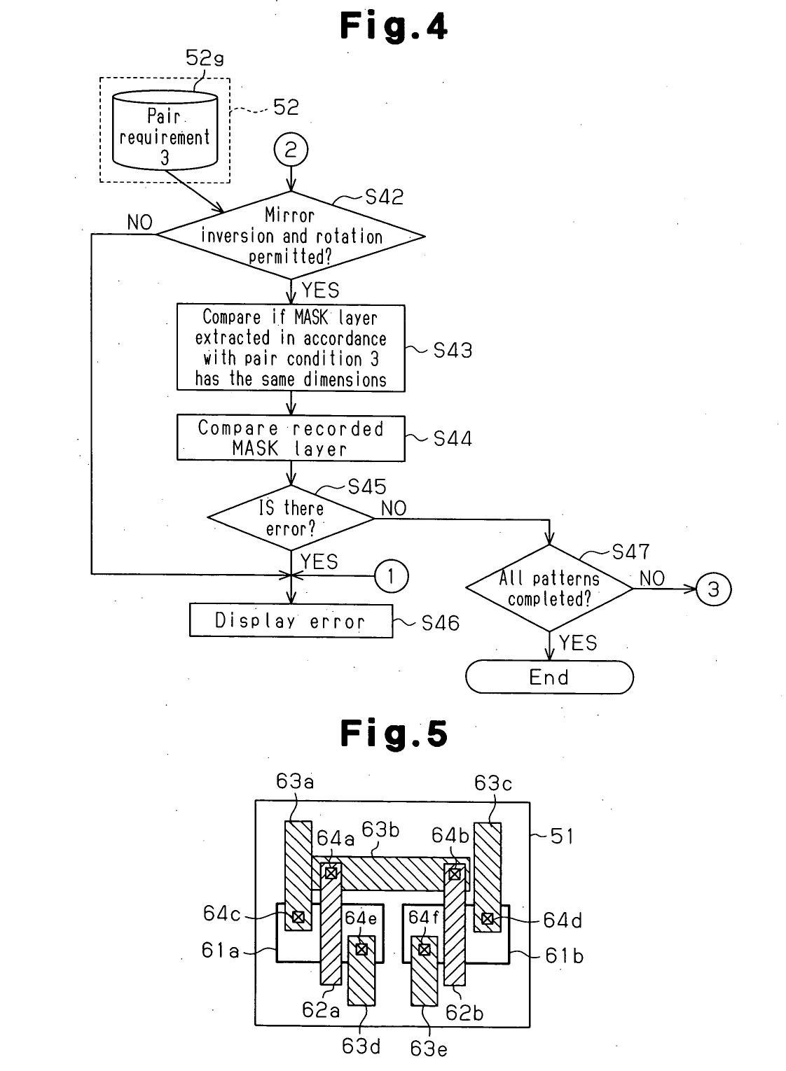

In FIGS. 3 and 4, steps 31 to 47 illustrate steps 21 to 26 of FIG. 2 in detail.

In step 31, the CPU 12 detects elements (instances) included in a semiconductor device based on a layout plan 51 and a control card 52. The control card 52 contains a layer definition 52a, which associates level codes and layer names, an interlayer connection definition 52b, which describes wiring layer definitions and hole definitions, and element extraction requirements 52c, which describe a mask layer calculation process for each type of the elements. For example, a MOS transistor includes a diffusion layer and a polysilicon pattern. Accordingly, as the requirements for extracting the MOS transistor, the element extraction requirements 52c include extracting overlapped portions between the figure of a mask layer for forming a diffusion layer and a mask layer for forming a polysilicon pattern. The control card 52 may be stored in a storage device such as the memory 13 or the magnetic disk 14.

The CPU 12 stores the contour coordinates of each instance in a coordinate database 53. The coordinate database 53 is generated in the memory 13 or the magnetic disk 14. Further, the CPU 12 extracts net information as the connection information of the figures contained in the layout plan 51 and stores a list of the net information (netlist) 54 in the memory 13 or the magnetic disk 14 shown in FIG. 1.

In step 32, the CPU 12 compares the netlist 54, which has been generated, and a netlist 55, which is generated during the circuit design. The CPU 12 then extracts the element name (instance name) from the netlist 55 for the element detected in step 31 based on the connection state of the element and generates a name database 56 storing the instance name.

In step 33, the CPU 12 determines whether or not the comparison in step 32 results in a match. If the comparison does not result in a match, the processing is suspended in step 34. In this case, the layout is modified by a designer or a tool and the layout inspection is performed again.

If the comparison between the netlists 54 and 55 results in a match in step 33, the CPU 12 proceeds to step 35, in which the CPU 12 determines the instance name as association information with the netlist 55 and stores the instance name thus determined in association with the contour coordinates (i.e., positional information) of each instance in the coordinate database 53. Further, the CPU 12 calculates standard coordinates of each element and stores the standard coordinates in the coordinate database 53.

In step 36, the CPU 12 converts the contour coordinates stored in the coordinate database 53 into coordinate values of the coordinate system having the reference point at the lower left corner of the figure. That is, in step 36, the CPU 12 unifies the orientations of the figures with respect to the reference position for all the instances stored in the coordinate database 53. The CPU 12 then stores the coordinate values obtained by the conversion and the coordinate values of the reference position in the coordinate database 53.

In step 37, the CPU 12 deletes unnecessary instances by referring to the control card 52. The control card 52 contains a pair request 52d, which describes the names of the instances that are to be paired in the layout, a first requirement 52e, which describes the distance between the elements and the element shapes as the pair requirement 1, and a second requirement 52f, which describes the requirement for checking the interference to the elements. The CPU 12 deletes information on the instances for which paired layout is not required from the coordinate database 53 by referring to the pair request 52d in the control card 52.

In step S37, the CPU 12 further inspects whether or not the instances left in the coordinate database 53 or the instances that are to be paired in the layout satisfy the first requirement 52e (pair requirement 1). The CPU 12 performs this inspection by extracting the contour coordinates and layout positions of the instance names, for which paired layout is requested from the coordinate database 53, and compares the shapes of the plurality of instances. Further, the CPU 12 calculates the distance between the instances based on the contour coordinates and the layout positions extracted from the coordinate database 53. Then, the CPU 12 compares the distance between the instances obtained by the calculation with the distance between the elements as specified in the pair requirement 1.

The inspection of the pair requirement 1 in step 37 is conducted only on the instances for which paired layout is requested. In step 38, the CPU 12 determines whether or not the pair requirement 1 is violated. If there is no violation, the CPU 12 proceeds to step 39. If there is a violation, the CPU 12 proceeds to step 46 shown in FIG. 4.

In step 39, the CPU 12 performs inspection based on the second requirement 52f (pair requirement 2) in the control card 52. The second requirement 52f stores interference requirements of the elements as a pair requirement 2. The interference requirements include names of mask layers that are to be inspected and search distances. A plurality of wiring layers having wiring patterns for transferring a signal may be used as mask layers during an exposure process in the manufacturing processes of the semiconductor device. In the layout plan 51, the data for the diffusion layer interconnection, gate wirings, and inter-element wirings each have information for the respective layers corresponding to the processes.

Each element is susceptible to influence from wiring formed near the element along the upper surface of the substrate of the semiconductor device as it receives subtle influence from wiring formed distant from the element. Therefore, the CPU 12 sets the area where the element is subject to the influence as the search area, and extracts the mask layer contained in the search area. When setting the search area, the CPU 12 enlarges the contour of the element of which instance name has been determined in step 35 in accordance with the search distance of the pair requirement 2. The CPU 12 then sets the enlarged figure (or figure having a contour similar to that of the element) as the search area. This makes it possible to easily set a search area having shapes corresponding to the contour of the element. The distance resulting in influence to the element differs depending on the mask layers. Therefore, different search distances are set for different mask layers.

The CPU 12 then extracts a figure from the set search area for each of the mask layers and converts the coordinate values of the extracted figure into coordinate values of the coordinates of which origin (0, 0) corresponds to the reference point of the search area of each of the mask layers. The CPU 12 then stores the coordinate values obtained by the conversion in a work region 57. That is, a search area is set for each of a plurality of elements (figures) that are to be inspected for paired layout in each mask layer, and a figure contained in each of the search areas is extracted. The coordinate values of the extracted figure are stored in the work region 57 after being converted into coordinate values of the coordinates of which origin corresponds to the reference point of each of the search areas.

In step 40, based on the coordinate values stored in the work region 57, the CPU 12 checks whether or not a figure contained in the extracted mask layer and present in the search area has the same shape as another figure contained in the same mask layer and present in another search area. The CPU 12 performs this check by matching the reference points of the search areas and subjecting the figures of the respective search areas to an exclusive OR (EOR) operation. After the EOR processing, figures having the same shapes and coordinate values do not remain in the search areas. Accordingly, when a figure remains in a search area after the EOR processing, the figures in the search area are not matched with each other. That is, for elements that are to be laid out as a pair, figures are respectively located at different positions for the elements. Therefore, the CPU 12 determines that paired layout has not been performed when figures exist in the search area after the EOR processing and determines that paired layout has been performed when figures exist in the search area.

Thus, the CPU 12 determines whether or not paired layout has been performed just by subjecting the figures to the EOR processing. The EOR processing does not impose much load on the CPU 12. In other words, the paired layout can be inspected in a short period of time.

In step 41, the processing is terminated if the shapes of the figures in the mask layers checked in step 40 are the same. If not, the processing proceeds to step 42 of FIG. 4.

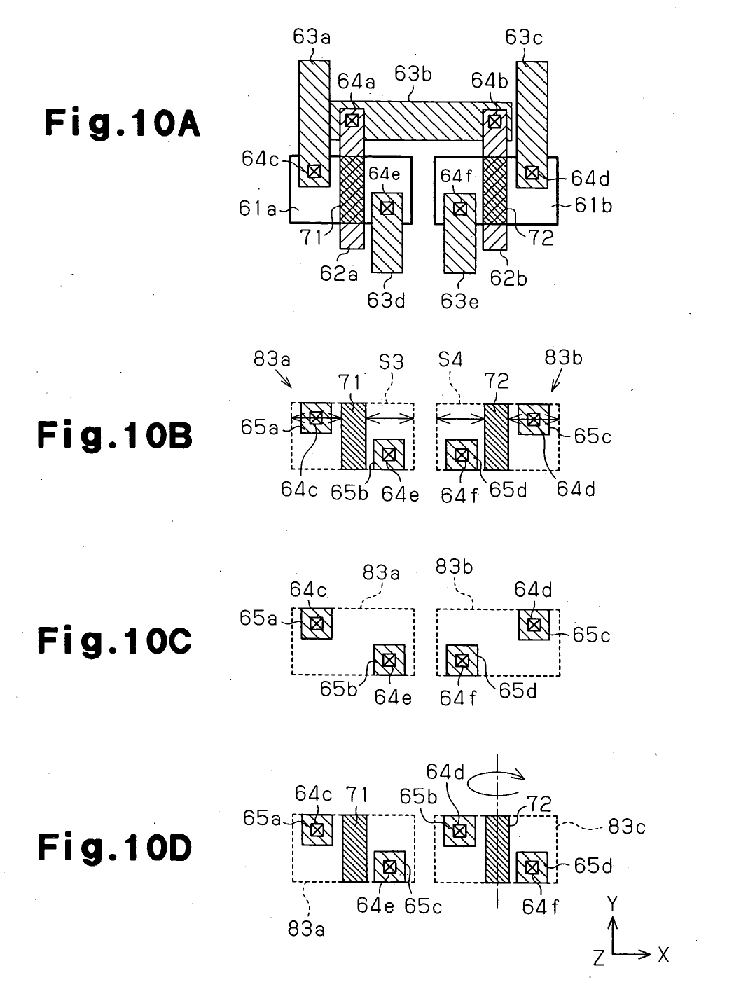

In step 42, the CPU 12 determines whether or not the mirror inversion or rotation of a figure is possible based on a third requirement 52g (pair requirement 3) in the control card 52. Examples of the pair requirement 3 are toleration of mirror inversion of a figure about the X-axis, toleration of mirror inversion of a figure about the Y-axis, or toleration of mirror inversion of the figure about the Z-axis (see FIG. 10D). In this example, the X-axis and Y-axis are parallel to the upper surface of the substrate of the semiconductor device, and the Z-axis is perpendicular to the upper surface of the substrate of the semiconductor device. If the inversion and the rotation are both not tolerated, the CPU 12 displays a paired layout error message on the display device 15 in FIG. 1 in step 46. By referring to the paired layout error message, the user may easily make corrections on elements that are not laid out in pairs. If either inversion or rotation is tolerated, the CPU 12 proceeds to step 43.

In step 43, the CPU 12 performs a tolerated conversion on one of the figures in the search areas extracted from the mask layer. Then, the CPU 12 converts coordinate values of the coordinate system of which origin corresponds to the apex in the same direction as other search areas. The CPU 12 then stores the coordinate value obtained by the conversion in the work region 57 shown in FIG. 3.

In step 44, the CPU 12 compares the figures in the search areas of the mask layer stored in the work region 57 in the same manner as in step 40. If the figures in the search areas do not match, the CPU 12 displays a paired layout error message in step 46. If the figures match, the CPU 12 determines, in step 47, whether or not the inspection has been completed for all the patterns. If the inspection has been completed for all the patterns, the processing is terminated, and an inspection completion message may be displayed on the display device 15. If the inspection has not been completed for all the patterns, the processing proceeds to step 37.

An example of a layout inspection conducted by the apparatus 11 according to a preferred embodiment of the invention will now be described.

FIG. 5 shows a layout plan 51 formed by figures having no hierarchy structure.

The layout plan 51 includes diffusion layer patterns 61a and 61b, polysilicon patterns 62a and 62b, metal patterns 63a to 63e, and hole patterns 64a to 64f. The layout plan 51 includes information of the figures as part of the layer (mask layer) data that is in accordance with the materials of the layers and the processes.

FIG. 6 shows part of the information contained in the control card 52, namely, the pair request 52d, the first requirement 52e, the element extraction requirement 52c, the interlayer connection definition 52b, and the second requirement 52f.

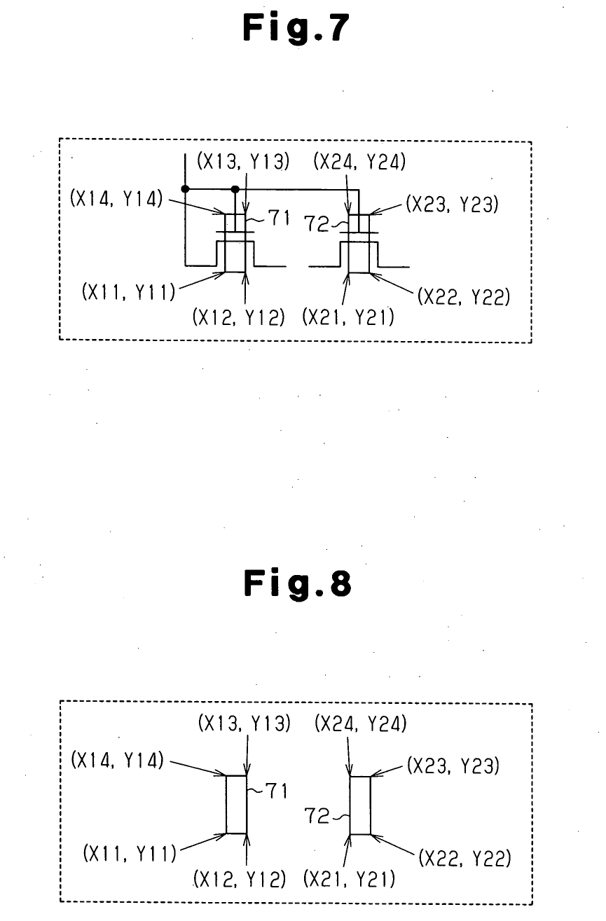

The apparatus 11 first extracts element shapes and connection information from the layout plan 51. In particular, the apparatus 11 extracts the overlapped portion between the polysilicon patterns 62a and 62b and the diffusion layer patterns 61a and 61b shown in FIG. 5 as MOS transistors 71 and 72 (see FIG. 7) based on the element extraction requirement 52c in the control card 52. The apparatus 11 then stores the contour coordinates of the MOS transistors 71 and 72 (e.g., the apex or angular coordinates) in the coordinate database 53 shown in FIG. 3. The apparatus 11 defines the terminals (the source, the drain, and the gate) of the MOS transistors 71 and 72 based on the element extraction requirement 52c. The apparatus 11 extracts connection information for the terminals of the MOS transistors 71 and 72 based on the interlayer connection definition 52b. The connection information is stored as the netlist 54 generated based on the layout plan 51.

The apparatus 11 then compares the netlist 54 with the netlist 55 generated based on the circuit design to determine instance names of the extracted MOS transistors 71 and 72. That is, the apparatus 11 searches the netlist 55 in the circuit design to extract a circuit element having the same connection state as the MOS transistors 71 and 72, and assigns the element name (instance name) of the extracted circuit element to the MOS transistors 71 and 72.

The apparatus 11 then performs paired layout inspection by checking the element shapes and the element interval in accordance with the first requirement 52e in the control card 52 shown in FIG. 6

The apparatus 11 first compares the shapes of the MOS transistors 71 and 72. The comparison of the shapes is performed by checking if the apex coordinates of the MOS transistors 71 and 72 match each other. If the shapes match, the apparatus 11 then inspects the element interval. If the shapes do not match, the apparatus 11 determines that the MOS transistors 71 and 72 are not paired in the layout.

The apparatus 11 then inspects whether the interval between the MOS transistors 71 and 72 is within an interval set in the first requirement 52e. If the interval between the MOS transistors 71 and 72 is within the set interval, the apparatus 11 proceeds to the next processing. If the interval between the MOS transistors 71 and 72 is not within the set interval, the apparatus 11 determines that the MOS transistors 71 and 72 are not paired in the layout.

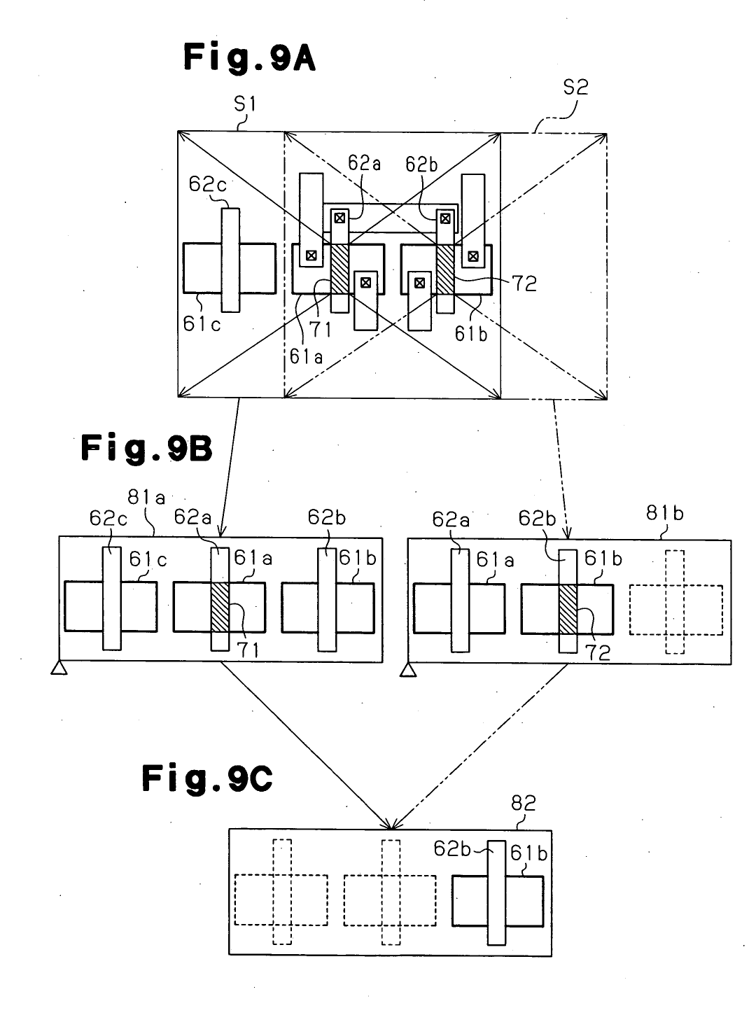

The apparatus 11 sets search areas S1 and S2 for the MOS transistors 71 and 72, respectively (see FIG. 9A). The size and the shapes of the search areas S1 and S2 are determined based on the shapes of the MOS transistors 71 and 72 and the second requirement 52f in the control card 52 (see FIG. 6). The apparatus 11 extracts the figures of the search areas S1 and S2 from the figures included in the set mask layer (e.g., the mask layer for forming polysilicon patterns, or the mask layer for forming diffusion layer patterns). FIG. 9B shows a figure group 81a extracted from the search area S1 for the MOS transistor 71 and a figure group 81b extracted from the search area S2 for the MOS transistor 72. Although the frames of the figure groups 81a and 81b have the same shapes as those of the search areas S1 and S2, the frames of the figure groups 81a and 81b are shown elongated in the lateral direction in FIGS. 9A to 9C for the purpose of simplicity.

The apparatus 11 determines the origin for each of the figure groups 81a and 81b. The origin is, for example, at the lower left apex or angle of each figure group. The apparatus 11 converts the coordinates of each figure in the figure groups 81a and 81b (the coordinates on the layout plan 51) into coordinates based on the corresponding origin. This coordinate conversion allows the figure coordinates to be represented by a relative value from the origin. This reduces the calculation load for the figure comparison between the figure groups. The figure groups 81a and 81b obtained by the conversion are then subjected to logic operation processing (EOR processing).

As shown in FIG. 9B, one of the figure groups, namely the figure group 81a, includes MOS transistors 71 and 72 (diffusion layer patterns 61a and 61b and polysilicon patterns 62a and 62b) that are to be inspected for paired layout, and an MOS transistor (a diffusion layer pattern 61c and a polysilicon pattern 62c) contained in the search area S1. The other figure group 81b includes only the MOS transistors 71 and 72 that are to be inspected for paired layout. As shown in FIG. 9C, the diffusion layer pattern 61b and the polysilicon pattern 62b remain in the comparison result between the figure groups 81a and 81b, that is, the comparison result of the logic operation processing 82. In this case, it is determined that the MOS transistors 71 and 72 are not paired in the layout.

Another example of a paired layout inspection using mirror inversion will now be described with reference to FIGS. 10A to 10D.

The apparatus 11 sets search areas S3 and S4 (see FIG. 10B) for the MOS transistors 71 and 72, respectively, according to the second requirement 52f in the control card 52 (AREA: Hole Metal−X=1 μm+X=1 μm−Y=0 μm+Y=0 μm MIR). The apparatus 11 searches data of the mask layer for forming metal wirings contained in the search areas S3 and S4 and the mask layer for forming holes to generate figure groups 83a and 83b shown in FIG. 10B. The figure group 83a includes the transistor 71, partial patterns 65a and 65b of metal patterns 63a and 63d, and hole patterns 64c and 64e. The figure group 83b includes the transistor 72, partial patterns 65c and 65d of metal patterns 63c and 63e, and hole patterns 64d and 64f.

FIG. 10C shows the result of logic operation processing (EOR processing) conducted on the figure groups 83a and 83b. The metal patterns 65a and 65b and the hole patterns 64c and 64e remain in the figure group 83a. The metal patterns 65c and 65d and the hole patterns 64d and 64f remain in the figure group 83b. Consequently, the figure groups 83a and 83b do not match.

However, in the second requirement 52f of the control card 52, the field for [AREA] designating the search area includes a description of an instruction [MIR] permitting mirror inversion of figures extracted from the mask layers [Hole, Metal] (see FIG. 6). Therefore, the apparatus 11 mirror-inverts the figure group 83b about the Y-axis to generate an inverted figure group 83c (see FIG. 10D). The apparatus 11 then compares the figure group 83a with the inverted figure group 83c. In this case, no figures remain in the logic operation result. Therefore, the apparatus 11 determines that the MOS transistors 71 and 72 are paired in the layout.

An example of paired layout inspection conducted on three or more element will now be described.

### EXAMPLE 1

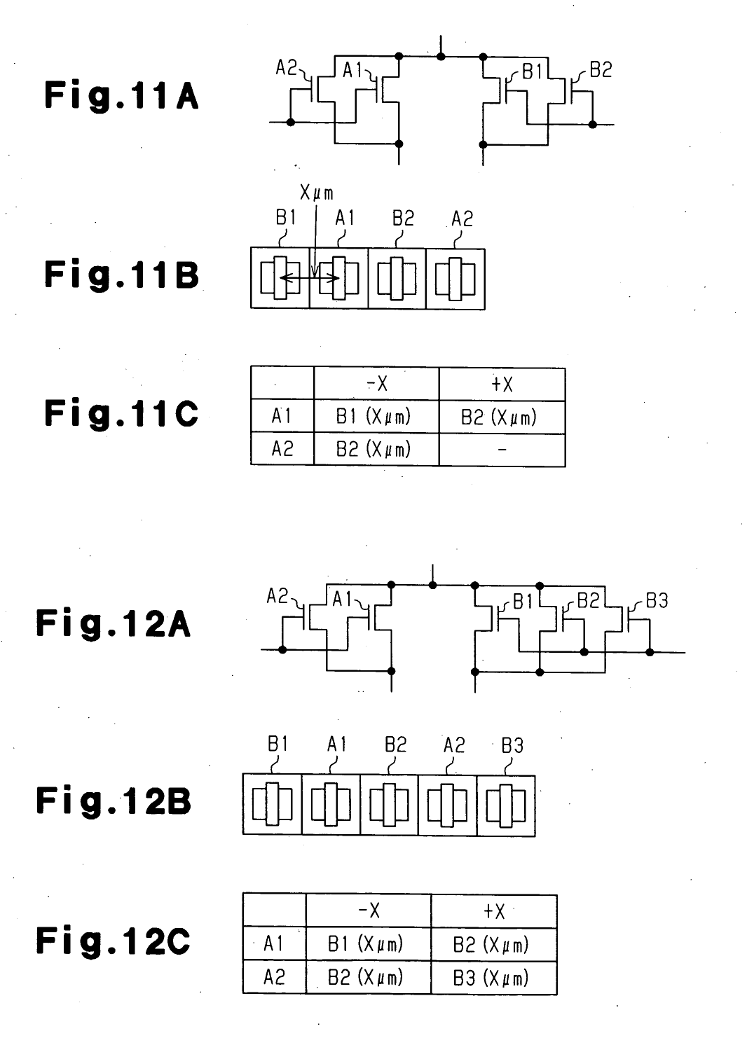

FIG. 11A is a circuit diagram of a differential circuit including four transistors A1, A2, B1, and B2. The transistors A1 and A2 are connected in parallel. The transistors B1 and B2 are connected in parallel. A transistor group A including the transistors A1 and A2 and a transistor group B including the transistors B1 and B2 are alternately arranged so that the transistor group A and the transistor group B have the same transistor characteristics. In the layout example shown in FIG. 11B, the four transistors are arranged in the sequence of the transistors B1, A1, B2, and A2.

In this case, the apparatus 11 sets coordinates for each of figures of the transistors based on the center position of the figure. The apparatus 11 calculates the distances (distances in the layout direction) from the transistors A1 and A2 of the transistor group A to the transistors B1 and B2 of the transistor group B. For example, the distances from the center position of the transistor A1 to the center positions of the transistors B1 and B2 are each X μm (the right direction represents the positive direction while the left direction represents the negative direction).

The apparatus 11 sets the following inspection requirements.

Distance requirement: all of the distances between the elements arranged along the layout direction (X-axis) match; and

Quantity requirement: the total number of transistor pairs for which the distances are calculated match the value obtained by subtracting 1 from the total number of transistors in the layout.

In the case shown in FIG. 11B, the apparatus 11 calculates the distances from the transistor A1 to the transistors B1 and B2, and the distance from the transistor A2 to the adjacent transistor B2. FIG. 11C shows the results of the calculation. All the distances obtained by the calculation match. The number of the transistor pairs for which the distances are calculated, namely “3”, matches the value obtained by subtracting 1 from the total number of the transistors in the layout. Consequently, it is determined that the transistors A1, A2, B1, and B2 arranged as shown in FIG. 11B are laid out in pairs.

### EXAMPLE 2

An inspection of two differential circuits having different numbers of transistors will now be described with reference to FIGS. 12A to 12C. As shown in FIG. 12B, transistors A1 and A2 belonging to a transistor group A and transistors B1 to B3 belonging to a transistor group B are alternately arranged. FIG. 12C shows the results of calculation of the distances from the transistor A1 to the adjacent transistors B1 and B2, and the distances from the transistor A2 to the adjacent transistors B2 and B3. All the distances match. Further, the number of the transistor pairs for which the distances are calculated, namely “4”, matches the value obtained by subtracting 1 from the total number of the transistors. Consequently, the apparatus 11 determines that the transistors A1, A2, B1, B2, and B3 arranged as shown in FIG. 12B are laid our in pairs.

### EXAMPLE 3

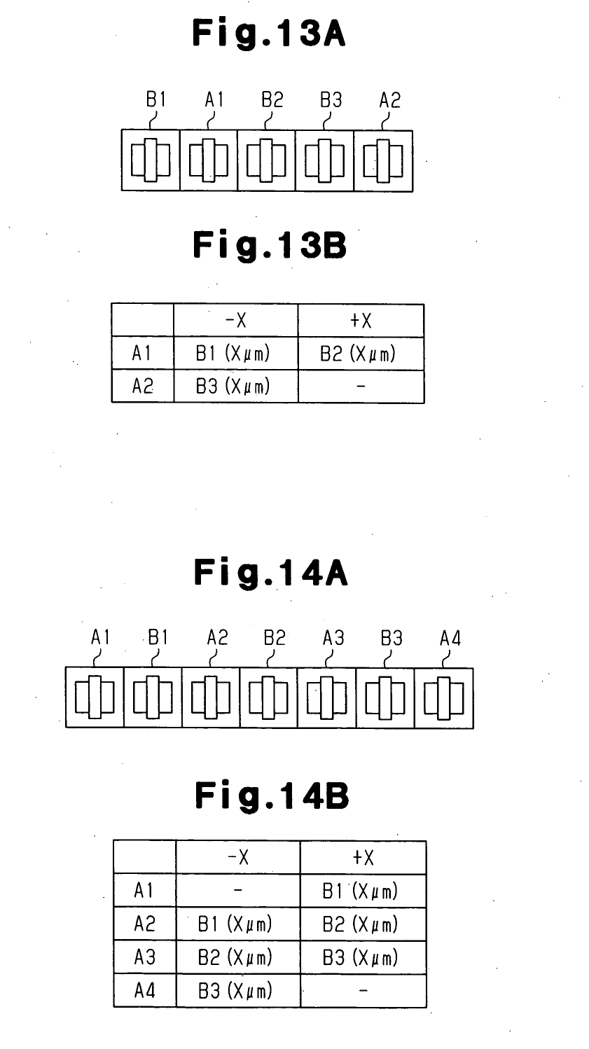

FIG. 13A is a modification of FIG. 12B. Transistors B2 and B3 in FIG. 13A are arranged adjacent to each other. In this case, the distances between adjacent elements calculated by the apparatus 11 are the distances from the transistor A1 to the transistors B1 ad B2, and the distance between the transistor A2 and the transistor B3. The number of the transistor pairs for which the distances are calculated, namely “3”, does not match the value obtained by subtracting 1 from the total number of the transistors arranged, namely “4”. Consequently, the apparatus 11 determines that the transistors A1, A2, B1, B2, and B3 shown in FIG. 13A are not laid out in pairs.

### EXAMPLE 4

In the example shown in FIG. 14A, transistors A1 to A4 and transistors B1 to B3 are alternately arranged. FIG. 14B shows the measurement results of distances between the adjacent transistors. In this case, all of the distances match, and the number of transistor pairs for which the distances are calculated, namely “6”, matches the value obtained by subtracting 1 from the total number of the transistors. Consequently, the apparatus 11 determines that the transistors A1 to A4 and B1 to B3 in FIG. 14A are paired in the layout.

### EXAMPLE 5

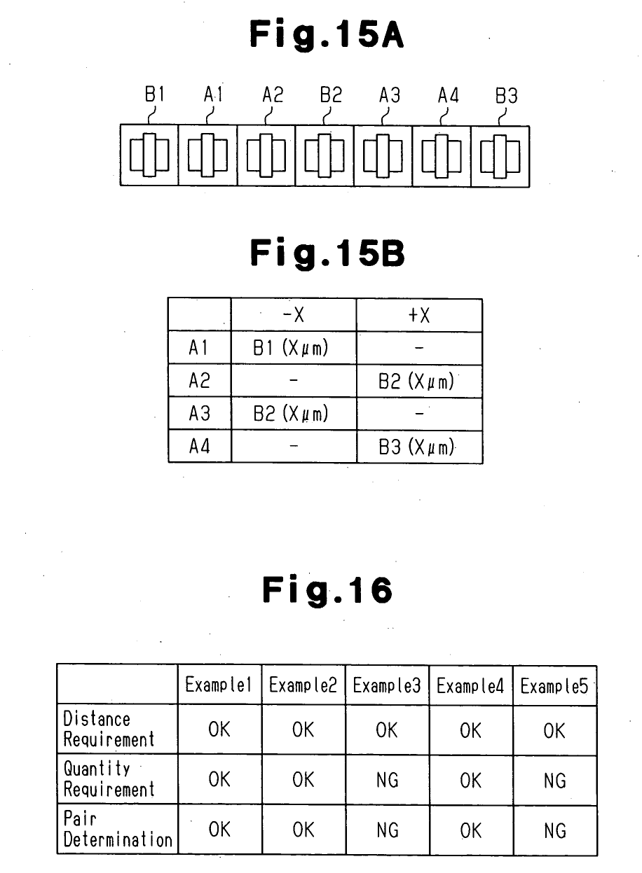

In the example shown FIG. 15A, transistors A1 and A2, and transistors A3 and A4 belonging to the same transistor group are adjacent to each other. FIG. 15B shows the measurement results of the distances between the adjacent transistors. In this case, all the distances match. However, the number of transistor pairs for which the distances are calculated, namely “4”, does not match the value obtained by subtracting 1 from the total number of the transistors, namely “6”. Consequently, the apparatus 11 determines that the transistors A1 to A4 and B1 to B3 shown in FIG. 15B are not laid out in pairs.

FIG. 16 shows the determination results of the distance and quantity requirements and the determination results of paired layouts for the examples 1 to 5. As for the determination results of the requirements, “OK” indicates that the requirement is satisfied, and “NG” indicates that the requirement is not satisfied. As for the determination results of the paired layouts, “OK” indicates that the transistors are laid out in pairs, and “NG” indicates that the transistors are not laid out in pairs.

An example of inspection of a layout in which extracted elements are arranged in two directions (X and Y directions) will now be described.

In this case, the apparatus 11 calculates the inter-element distances for each of the X and Y directions. The apparatus 11 sets the following inspection requirements.

Distance requirement A: all the distances between adjacent elements match in the first direction (±X directions);

Distance requirement B: all the distances between adjacent elements match in the second direction (±Y directions); and

Quantity requirement: the total number of transistor pairs for which the distances are calculated must match the value obtained by subtracting 1 from the total number of transistors in the layout.

### EXAMPLE 6

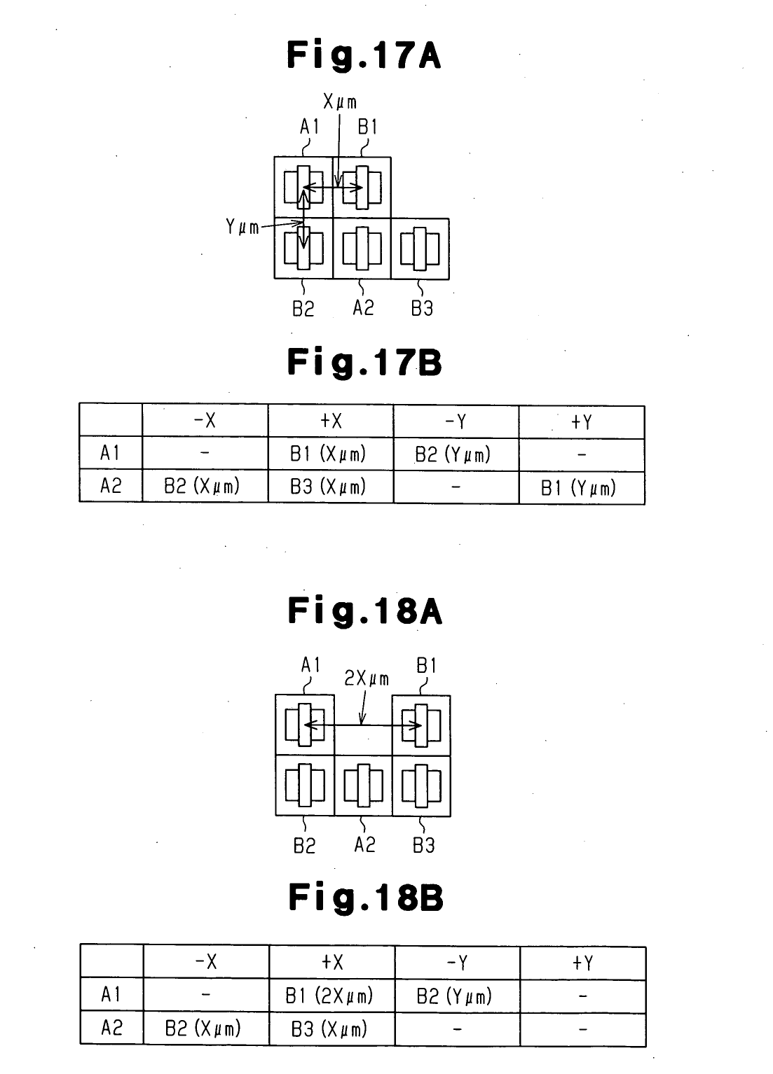

In the example shown in FIG. 17A, transistors A1 and A2 belonging to a first transistor group and transistors B1 to B3 belonging to a second transistor group are arranged in a checkered pattern. FIG. 17B shows the results of calculation of the inter-element distances. In this case, the calculated distances in the X direction match, and the calculated distances in the Y direction also match. Further, the number of transistor pairs for which the distances are calculated, namely “5”, matches the total number of transistors in the layout. Consequently, the apparatus 11 determines that the transistors A1, A2, and B1 to B3 shown in FIG. 17A are laid out in pairs.

The same results are obtained even if the transistor B3 is omitted from example 6.

### EXAMPLE 7

In the example shown in FIG. 18A, transistors A1 and A2 of a first transistor group and transistor B1 to B3 of a second transistor group are arranged in a checkered pattern. FIG. 18B shows the results of calculation of the inter-element distances. In this case, the number of transistor pairs for which the distances are calculated, namely “5”, matches the total number of the transistors in the layout. However, the distance between the transistor A1 and the transistor B1 in the X distance differs from the distances from the transistor A2 to the transistors B2 and B3 in the X direction. Consequently, the apparatus 11 determines that the transistors A1, A2, and B1 to B3 arranged as shown in FIG. 18A are not laid out in pairs.

### EXAMPLE 8

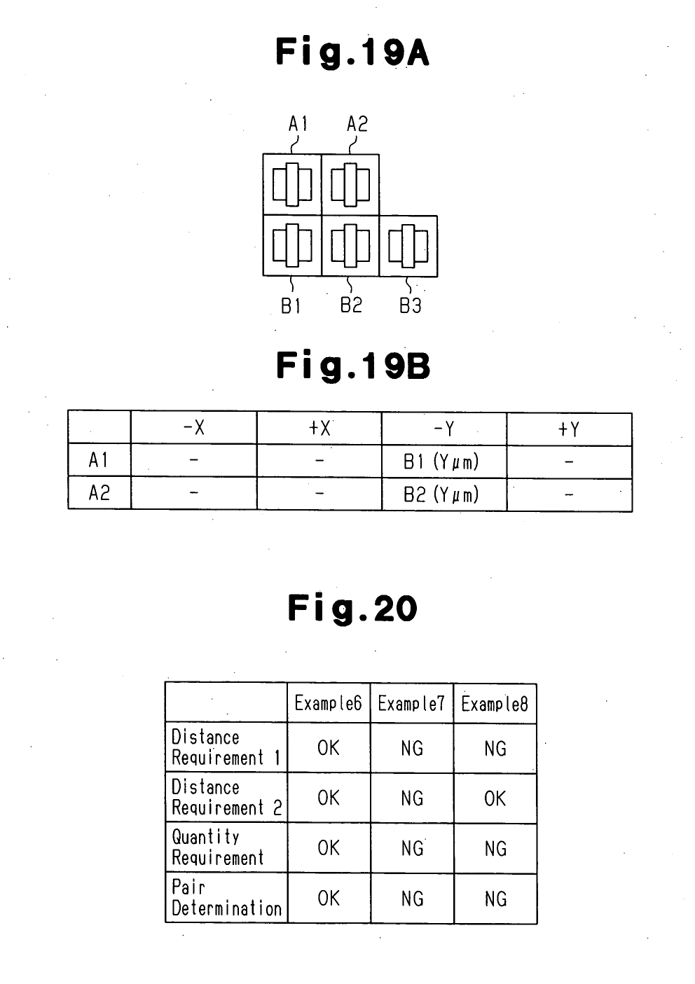

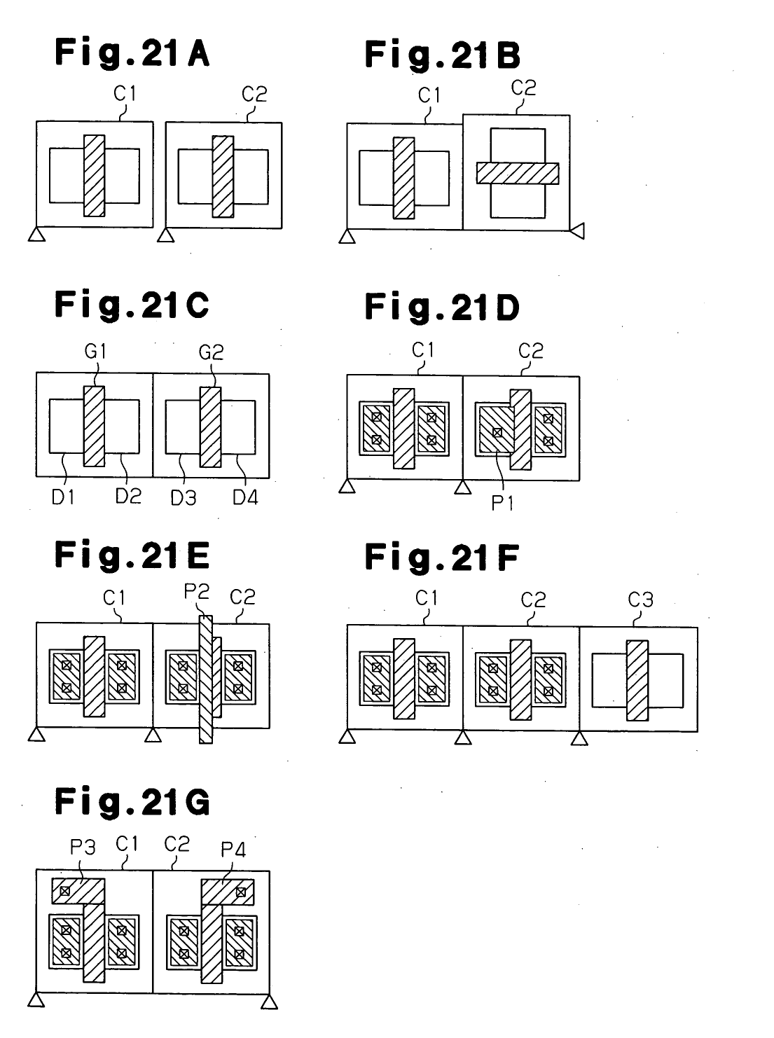

In the example shown in FIG. 19A, transistors A1 and A2 of a first transistor group and transistors B1 to B3 of a second transistor group are arranged in separate rows. FIG. 19B shows the results of calculation of inter-element distances. In this case, the distances in the row direction (X direction) are not calculated. The distances in the Y direction match each other. The number of transistor pairs for which the distances are calculated, namely “2”, does not match the total number of transistors in the layout, namely, “5”. Consequently, the apparatus 11 determines that the transistors A1, A2, and B1 to B3 in FIG. 19A are not laid out in pairs.

FIG. 20 shows the determination results of the distance requirements A and B and the quantity requirement, and the determination results of paired layouts for the examples 6 to 8. As for the determination of the requirements, “OK” indicates that the requirement is satisfied, and “NG” indicates that the requirement is not satisfied. As for the determination of the paired layout, “OK” indicates that the elements are laid out in pairs, and “NG” indicates that the elements are not laid out in pairs.

The preferred embodiment of the present invention has the advantages described below.

(1) Paired layout inspection requirements are set to include at least an inter-element interval at which a paired layout is enabled. A plurality of elements are first inspected for paired layout based on the inspection requirements. A search area is set for each element and figures contained in the search areas of the elements are extracted. Then, it is determined whether or not the shapes of the extracted figures are the same for the elements that are to be inspected for paired layout. Thus, the shapes and layout positions of components such as wiring in the search area are checked for each of the plurality of elements paired in the layout. This reduces the determination errors in the paired layout inspection.

(2) The shapes and coordinate values of an element detected from the layout plan 51 of a semiconductor device are stored. The detected element is selectively subjected to the inspection processing. This makes it possible to perform paired layout inspection even if the layout plan 51 has no hierarchy structure. This reduces the time and trouble required for visual checking.

It should be apparent to those skilled in the art that the present invention may be embodied in many other specific forms without departing from the spirit or scope of the invention. Particularly, it should be understood that the present invention may be embodied in the following forms.

The paired layout inspection requirements and settings are not necessarily contained in the control card 52, but may be divided into two or more files to be stored.

The present examples and embodiments are to be considered as illustrative and not restrictive, and the invention is not to be limited to the details given herein, but may be modified within the scope and equivalence of the appended claims.

What is claimed is:

1. A layout inspection method for inspecting the layout of a plurality of elements included in a semiconductor device, the method comprising:
setting paired layout inspection requirements including at least an element interval at which a paired layout is enabled;
inspecting whether or not the elements that are to be inspected for paired layout satisfy the paired layout inspection requirements;
setting a search area for each of the elements that are to be inspected for paired layout; and
extracting figures included in the search areas of the elements that are to be inspected for paired layout and inspecting whether or not the extracted figures of the elements that are to be inspected for paired layout are congruent to each other.

2. The layout inspection method according to claim 1, further comprising:
detecting elements from layout data of the semiconductor device before said setting of the inspection requirements and storing shapes and coordinate values of the detected elements;
wherein said inspecting includes selectively inspecting the elements detected from the layout data.

3. The layout inspection method according to claim 2, further comprising:
generating and storing connection information extracted from the layout data for the detected elements; and
comparing the connection information with a netlist of the semiconductor device to determine element names of the detected elements.

4. The layout inspection method according to claim 1, wherein the setting of the search area includes enlarging the figures extracted for inspection in accordance with a set value.

5. The layout inspection method according to claim 1, wherein the plurality of elements include a first element and a second element, each element having a plurality of components, and when said extracting figures determines that the shapes are different, the method further comprising:
generating a figure of the first element that has been inverted and/or rotated by executing at least one of:
inverting at least one of the components included in the first element about a predetermined axis extending across the first element; and
rotating the at least one component about an axis perpendicular to the first element by a predetermined angle; and
inspecting whether or not the figure of the first element that has been inverted and/or rotated has a shape that is congruent to that of a figure of the second element.

6. The layout inspection method according to claim 2, wherein the layout data contains data for a plurality of mask layers corresponding to a manufacturing process for the semiconductor device, and the search area is set for each of the mask layers.

7. The layout inspection method according to claim 1, wherein said extracting figures includes:
setting a predetermined position in the corresponding search area as the origin for each element;
converting the coordinate values of each element into coordinates based on the origin; and
comparing the shapes of the elements that are to be inspected for paired layout by using the coordinate values after the conversion.

8. The layout inspection method according to claim 1, wherein said extracting figures includes:
setting a predetermined position of each search area as the origin;
converting the coordinate values of a plurality of figures forming each element into coordinates based on the origin; and
comparing the shapes of the elements that are to be inspected for paired layout by using the converted coordinate values of the plurality of figures after the conversion.

9. The layout inspection method according to claim 1, further comprising:
displaying an error message when the comparison result of the figures indicates a mismatch.

10. A layout inspection apparatus for inspecting the layout of a plurality of elements included in a semiconductor device, the apparatus comprising:
a processing circuit programmed to:
set paired layout inspection requirements including at least an element interval at which a paired layout is enabled;
inspect whether or not the elements that are to be inspected for paired layout satisfy the paired layout inspection requirements;
set a search area for each of the elements that are to be inspected for paired layout;
extract figures included in the search areas of the elements that are to be inspected for paired layout; and
inspect whether or not the extracted figures of the elements that are to be inspected for paired layout are congruent to each other; and
a memory device, connected to the processing circuit, for holding the paired layout inspection requirements.

11. The apparatus according to claim 10, wherein the processing circuit is programmed to detect elements from layout data of the semiconductor device before said setting of the inspection requirements and storing shapes and coordinate values of the detected elements in the memory device, and the inspecting includes selectively inspecting the elements detected from the layout data.

12. The apparatus according to claim 11, wherein the processing circuit is programmed to:
generate connection information extracted from the layout data for the detected elements and stores the connection information in the memory device; and
compare the connection information with a netlist of the semiconductor device to determine element names of the detected elements.

13. The apparatus according to claim 10, wherein the processing circuit is programmed to enlarge the figures extracted for inspection in accordance with a set value when setting the search area.

14. The apparatus according to claim 10, wherein the plurality of elements include a first element and a second element, each element having a plurality of components, and when determining that the shapes are different during the inspecting, the processing circuit is programmed to:
generate a figure of the first element that has been inverted and/or rotated by executing at least one of:
inverting at least one of the components included in the first element about a predetermined axis extending across the first element; and
rotating the at least one component about an axis perpendicular to the first element by a predetermined angle; and
inspect whether or not the figure of the first element that has been inverted and/or rotated has a shape that is congruent to that of a figure of the second element.

15. The apparatus according to claim 11, wherein the layout data contains data for a plurality of mask layers corresponding to a manufacturing process for the semiconductor device, and the processing circuit is programmed to set the search area for each of the mask layers.

16. The apparatus according to claim 10, wherein the processing circuit is programmed to:
set a predetermined position in the corresponding search area as the origin for each element;
convert the coordinate values of each element into coordinates based on the origin; and
compare the shapes of the elements that are to be inspected for paired layout by using the coordinate values after the conversion.

17. The apparatus according to claim 10, wherein the processing circuit is programmed to:
set a predetermined position of each search area as the origin;
convert the coordinate values of a plurality of figures forming each element into coordinates based on the origin; and
compare the shapes of the elements that are to be inspected for paired layout by using the converted coordinate values of the plurality of figures after the conversion.

18. The apparatus according to claim 10, further comprising:
a display device for displaying an error message when the comparison result of the figures indicates a mismatch.
